(19) United States
(12) Patent Application Publication
(10) Pub. No.: US 2021/0043895 A1
(43) Pub. Date: Feb. 11, 2021

(54) BATTERY PACK AND PROPULSION DEVICE

(71) Applicant: Yanmar Power Technology Co., Ltd., Osaka (JP)

(72) Inventors: Hideaki AOKI, Osaka (JP); Taro OKAMATSU, Osaka (JP)

(73) Assignee: Yanmar Power Technology Co.,, Osaka (JP)

(21) Appl. No.: 16/966,836

(22) PCT Filed: Jan. 29, 2019
(86) PCT No.: PCT/JP2019/002956

§ 371 Date: Jul. 31, 2020

(30) Foreign Application Priority Data
Feb. 1, 2018 (JP) 2018-016816

(51) Int. Cl. H01M 2/10; B63B 32/10; B63H 21/17; H01M 2/20; H01M 2/30

(52) U.S. Cl. CPC H01M 2/1077; B63B 32/10; H01M 2220/20; H01M 2/206; H01M 2/305; B63H 21/17

(57) ABSTRACT

This battery pack (30) is provided with a front casing (31) and a plurality of battery modules. Each battery module has a cylindrical battery group (42) and connection members (46). In the cylindrical battery group (42), a plurality of cylindrical batteries (42a) are aligned in a direction that is perpendicular to the axial direction to form a first space (43) between the cylindrical batteries and an inner wall of the front casing (31) when viewed in the axial direction. The connection members (46) are fitted to both ends of the cylindrical battery group (42) in the axial direction so as to connect the terminals of the cylindrical batteries (42a). The battery modules are aligned in the axial direction, and the connection members (46) of battery modules adjacent to each other are affixed to each other at portions that are positioned in the first space (43).

### TECHNICAL FIELD

The present invention mainly relates to a battery pack including a plurality of cylindrical batteries.

### BACKGROUND ART

Conventionally, as disclosed in Patent Literature 1 and the like, underwater propulsion devices that generate a propulsive force using an electric motor as a drive source are known. Patent Literature 1 discloses an arrangement of eight cylindrical batteries (battery 61) inside the propulsion device for driving an electric motor.

### CITATION LIST

### Patent Literature

Patent Literature 1: US Patent Application Publication No. 2003/0167991, specification

### DISCLOSURE OF INVENTION

### Problems to be Solved by the Invention

Here, when a single battery pack is configured using a plurality of batteries, it is necessary to connect the batteries in series or in parallel. However, Patent Literature 1 does not describe the structure for connecting the batteries inside the propulsion device. Because the battery capacity of a battery pack increases as the space in which the batteries are arranged becomes larger, an efficient use of space is desired. Furthermore, because it is necessary to connect the batteries to each other, a simple connection operation that enables the batteries to be connected to each other is desired. Note that these circumstances are not limited to batteries for propulsion devices placed underwater, and similarly apply to batteries for other applications.

The present invention has been made in view of the above circumstances, and the primary object of the present invention is to provide a battery pack capable of utilizing the spaces formed between the batteries and the casing of the battery pack, while also ensuring a sufficient battery capacity.

### Means for Solving the Problems

The problem to be solved by the present invention is as described above, and the means for solving the problem and the effects thereof will be described below.

According to an aspect of the present invention, a battery pack having the following configuration is provided. That is to say, the battery pack includes a battery casing and a plurality of battery modules. The plurality of battery modules are housed in the casing. Each battery module is provided with a cylindrical battery group and a connection member. In the cylindrical battery group, a plurality of cylindrical batteries, each of which is provided with terminals at both ends in an axial direction, are aligned in a direction that is perpendicular to the axial direction to form a first space between the plurality of cylindrical batteries and an inner wall of the battery casing when viewed in the axial direction. Each of the connection member is fitted to both ends of the cylindrical battery group in the axial direction so as to connect the terminals of the plurality of cylindrical batteries to each other, and is partially positioned in the first space when viewed in the axial direction. The plurality of battery modules are arranged to align in the axial direction, and the connection members of the battery modules adjacent to each other are affixed to each other at portions that are positioned in the first space.

According to the battery pack described above, the cylindrical batteries are aligned so as to form the first space, and the connection members are positioned in the first space. As a result, when a battery module is aligned in the axial direction, part of the connection member is exposed. Therefore, the work of affixing adjacent connection members to each other can be easily performed. Furthermore, by having a plurality of battery modules, a large battery capacity can be ensured.

In the battery pack described above, the plurality of cylindrical batteries are preferably aligned to form a second space at a center of each of the plurality of cylindrical battery groups when viewed in the axial direction.

As a result, when the battery pack is viewed from the axial direction, a space is formed that passes through the center of each battery module in the axial direction. Therefore, for example, by arranging a component (such as a harness) included in the battery pack in this space, the internal space of the battery casing can be effectively utilized.

In the battery pack described above, each of the plurality of battery modules preferably includes a holder that holds the cylindrical battery group. The holder is arranged to avoid overlapping with affixed portions of the connection members in the first space when viewed in the axial direction.

As a result of the cylindrical battery group being held by the holder, the cylindrical batteries can be stabilized. Furthermore, by arranging the holder so as to not overlap with an affixed portion between the connection members when viewed in the axial direction, the ease of performing the work of affixing the connection members to each other is maintained even when the holder is provided.

In the battery pack described above, it is preferable for battery holding holes to be formed in the holder for individually holding the plurality of cylindrical batteries, and for battery holding holes adjacent to each other to be partitioned by a wall part.

As a result of the cylindrical batteries being partitioned by a wall part, it is possible to prevent fire from spreading between the cylindrical batteries.

The battery pack described above preferably has the following configuration. That is to say, the battery pack includes a joining member that joins a plurality of holders arranged to align in the axial direction. The cylindrical battery groups of the plurality of battery modules are aligned to form a third space between the cylindrical battery groups and the inner wall of the battery casing. The joining member is arranged so as to pass through the plurality of holders positioned in the third space.

As a result of the holders being joined by the joining member, the battery modules can be stabilized inside the battery casing. Furthermore, because the holders are joined by utilizing the third space, which is a space formed between the cylindrical batteries and the battery casing, the internal space of the battery casing can be effectively utilized.

In the battery pack described above, at least part of the cylindrical battery group is preferably arranged along an outline of a regular hexagon when viewed in the axial direction.

As a result, because the cylindrical batteries can be arranged with a high density, the internal space of the battery casing can be effectively utilized.

The propulsion device described above preferably has the following configuration. That is to say, the propulsion device includes a battery pack, a drive source, and a propulsion unit. The drive source is driven by electric power supplied from the battery pack. The propulsion unit uses a drive force generated by the drive source to generate a propulsive force that moves a moving body.

The propulsion device described above includes a plurality of battery modules. As a result, a propulsion device having a large battery capacity is realized.

The propulsion device described above preferably has the following configuration. The propulsion device includes a drive casing that houses the drive source. The battery casing constitutes an outer shell of the propulsion device and is configured so as to be detachable from the drive casing, and is provided with an external terminal for charging the cylindrical battery groups of the plurality of battery modules by means of an external charging device. Furthermore, the propulsion unit generates the propulsive force underwater.

According to the propulsion device described above, the battery casing also serves as a casing of the propulsion device. As a result, a large space for arranging the cylindrical battery groups can be ensured, and the propulsion device can be made compact. Furthermore, because an external terminal is provided on the battery casing, which is detachable from the drive casing, it is possible to charge the cylindrical battery groups in a state where the drive casing is detached from the battery casing. Moreover, an effect can exhibited in which the internal space of the battery casing can be effectively utilized in a propulsion device for underwater use, while ensuring a sufficient battery capacity.

### BRIEF DESCRIPTION OF DRAWINGS

FIG. 1 is a perspective view showing a configuration of an electric sliding body including a propulsion device according to a first embodiment of the present invention.

FIG. 2 is a cross-sectional view of the propulsion device taken along a plane parallel to the axial direction (a cross-sectional view from the arrow direction of the line A-A in FIG. 1).

FIG. 3 is a perspective view showing a configuration of a battery pack in a state where the front casing, the lid, and the like have been removed.

FIG. 4 is a cross-sectional view of the battery pack taken along a plane perpendicular to the axial direction (a cross-sectional view from the arrow direction of the line B-B in FIG. 1).

FIG. 5 is a cross-sectional view of a holder of a first modification, in which a battery holding hole has also been formed in the center when viewed in the axial direction.

FIG. 6 is a cross-sectional view of a holder of a second modification, in which 36 battery holding holes have been formed.

FIG. 7 is a cross-sectional view of a holder of a third modification, in which 18 battery holding holes have been formed.

FIG. 8 is a side view of an all-terrain vehicle provided with a propulsion device according to a second embodiment.

### DESCRIPTION OF EMBODIMENTS

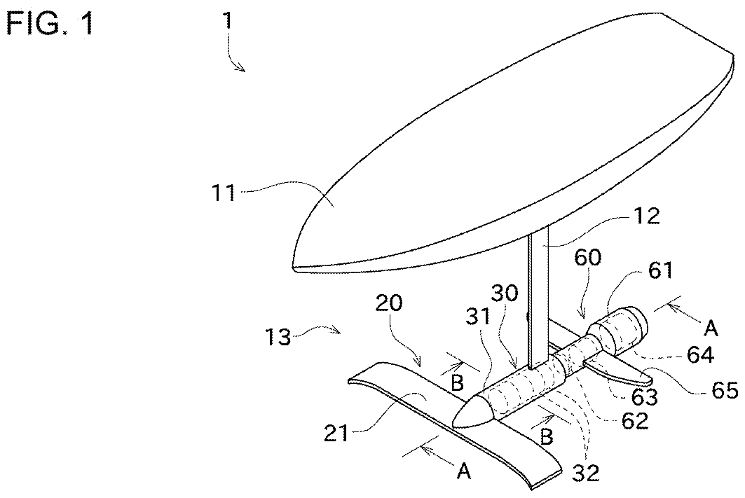

Next, a first embodiment of the present invention will be described with reference to the drawings. FIG. 1 is a perspective view showing a configuration of an electric sliding body 1 including a propulsion device 13 according to a first embodiment. Furthermore, in the following description, front, rear, left, and right are defined such that the forward direction of the electric sliding body 1 is the front. In the electric sliding body 1 shown in FIG. 1, the electric sliding body 1 is a vehicle that slides on water by acquiring thrust from electric power. As shown in FIG. 1, the electric sliding body 1 includes a surfboard 11, a support column 12, and a propulsion device 13.

The surfboard 11 is a plate-shaped member having a flat upper surface. The surfboard 11 slides over water as a result of the propulsion device 13 generating a propulsive force in a state where a person is riding on the upper surface of the surfboard 11. Another member that travels over water or underwater may be provided instead of the surfboard 11. Furthermore, a support column 12 is connected to the lower surface of the surfboard 11. The support column 12 extends downward from the lower surface of the surfboard 11, and is connected to the upper surface of the propulsion device 13.

The propulsion device 13 generates a propulsive force for propulsion of the surfboard 11 from electric power. The propulsion device 13 includes a head unit 20, a battery pack 30, and an operating unit 60.

The head unit 20 is a part that configures the front portion of the propulsion device 13. The head unit 20 has a shape whose outer diameter decreases toward the front. A front foil 21 is connected to the head unit 20. The front foil 21 is arranged so as to extend from the head unit 20 in the left-right direction. The front foil 21 generates a levitation force in the electric sliding body 1 and stabilizes the behavior of the electric sliding body 1 during propulsion.

The battery pack 30 is a part that stores electric power used to generate a propulsive force. The battery pack 30 is detachably fitted to the rear of the head unit 20. The battery pack 30 is configured to include a plurality of cylindrical batteries. Electric power can be supplied to the operating unit 60 as a result of this configuration. The detailed configuration of the battery pack 30 will be described later.

The operating unit 60 is a part that generates a propulsive force. The operating unit 60 is detachably fitted to the rear of the battery pack 30. Therefore, the battery pack 30 of the present embodiment is configured to be separable from the head unit 20 and the operating unit 60. The operating unit 60 includes a rear casing (drive casing) 61, an inverter 62, an electric motor (drive source) 63, a screw (propulsion unit) 64, and a rear foil 65. The inverter 62, the electric motor 63, and the screw 64 are arranged inside the rear casing 61. The direct current supplied from the battery pack 30 is converted into alternating current having a predetermined frequency by the inverter 62, and then supplied to the electric motor 63. The electric motor 63 generates a driving force from the alternating current supplied from the inverter 62, and rotates the screw 64. The operating unit 60 generates a propulsive force as a result of the configuration above. Furthermore, in a similar manner to the front foil 21, the rear foil 65 generates a levitation force in the electric sliding body 1 and stabilizes the behavior of the electric sliding body 1 during propulsion.

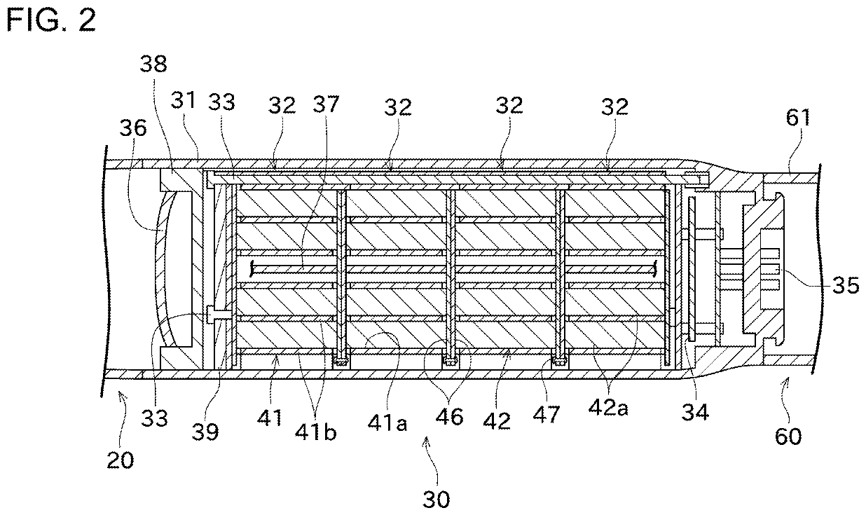

Next, the configuration of the battery pack 30 will be described in detail mainly with reference to FIG. 2. FIG. 2 is a cross-sectional view of the propulsion device 13 taken along a plane parallel to the axial direction. Furthermore, FIG. 2 is a cross-sectional view from the arrow direction of the line A-A in FIG. 1. As shown in FIG. 2, the battery pack 30 includes a front casing (battery casing) 31, battery modules 32, joining bolts (joining members) 33, an external terminal 35, a battery control board 34, and a handle 36.

The front casing 31 is a member for housing the parts that constitute the battery pack 30. The front casing 31 is formed in a substantially circular cylindrical shape. The front casing 31 of the present embodiment has a shape in which the length in the axial direction is shorter than the length in the radial direction (that is to say, a thin shape). As a result of forming the front casing 31 in such a circular cylindrical shape, the water pressure applied to the front casing 31 becomes uniform, and therefore, high pressure resistance can be realized with a simple structure. The front casing 31 and the rear casing 61 are detachably configured.

Furthermore, the front casing 31 of the present embodiment constitutes the outer shell of the propulsion device 13 and also constitutes the casing of the battery modules 32. In other words, the front casing 31 has both a function as a casing for protecting the inside from external environments such as water, and a function for organizing the battery modules 32. Therefore, the space in the battery pack 30 can be efficiently utilized relative to a configuration that includes two casings provided with the respective functions.

Furthermore, the front casing 31 of the present embodiment is not produced by joining two semi-circular cylindrical members, but is formed with a circular cylindrical shape from the beginning. Therefore, no joint marks or the like are formed on the outer peripheral surface of the front casing 31. As a result, it is possible to prevent water from entering the outer peripheral surface with a simple configuration, and without performing the work of providing a sealing material at a joint part or the like. Furthermore, in the present embodiment, the battery pack 30 is produced by pre-assembling the members to be arranged inside the front casing 31, and then inserting the assembly into the front casing 31. As a result, a structure in which the assembly is fixed by simply being inserted into the front casing 31, or a structure in which the assembly is fixed so as to restrict movements in the axial direction, is employed. Therefore, the battery pack 30 can be conveniently produced even when a front casing 31 not having a split construction is employed.

The front casing 31 may have a shape other than a circular cylindrical shape. For example, a cylindrical front casing 31 having a polygonal cross section, or a front casing 31 whose length in the axial direction is longer than the length in the radial direction can also be employed. A cylindrical front casing 31 having a polygonal cross-section may have rounded corner portions. It is preferable that the front casing 31 has a convex shape (roundness) on the outside, and is substantially not provided with a flat portion. Furthermore, the outer shell of the propulsion device 13 and the casing of the battery modules 32 may be separate. In addition, the front casing 31 may be produced by joining a plurality of members.

The battery modules 32 have a configuration in which a cylindrical battery group 42 including a plurality of cylindrical batteries 42a is held by a holder 41. The cylindrical batteries 42a are, for example, circular cylindrical lithium ion batteries having a positive terminal and a negative terminal, each of which is formed at both ends in the axial direction. In the following description, the axial direction of the cylindrical batteries 42a may be simply referred to as the “axial direction”. Furthermore, the axial direction in the present embodiment is the same direction as the propulsion direction of the propulsion device 13, and the axial direction of the front casing 31. The detailed configuration of the battery module 32 will be described later. In the front casing 31, a plurality of battery modules 32 are arranged to align in the axial direction. A joining bolt 33 joins the plurality of battery modules 32 being arranged to align to each other.

The battery control board 34 is arranged on one side (the operating unit 60 side) of the battery modules 32 in the axial direction. The battery control board 34 performs processing for realizing a BMS (battery management system). Specifically, the battery modules 32 are provided with, for example, a voltage sensor that detects the voltage value of each cylindrical battery 42a and a temperature sensor that measures the ambient temperature of the cylindrical batteries 42a. The battery control board 34 acquires the detection results of the voltage sensor and the temperature sensor via a harness 37. Based on the detection results, the battery control board 34 performs controls that prevent excessive charging when the cylindrical batteries 42a are being charged, and prevents excessive discharging when power is supplied from the cylindrical batteries 42a to the operating unit 60. Furthermore, the battery control board 34 can output data relating to the cylindrical battery groups 42 to the outside. In the present embodiment, the battery control board 34 can output data to the outside via a wired LAN, but it may be configured to output wirelessly. In addition, a configuration may be used in which the detection results of the voltage sensor and the temperature sensor are acquired wirelessly instead of via the harness 37.

The external terminal 35 is provided on one side (the operating unit 60 side) of the battery control board 34 in the axial direction, that is to say, on an end of the front casing 31 in the axial direction. The external terminal 35 can be connected to a charging terminal of a charging device, and a power supply terminal of the operating unit 60. By connecting the charging terminal to the external terminal 35, the cylindrical batteries 42a included in the battery modules 32 can be charged. By connecting the power supply terminal to the external terminal 35, electric power can be supplied to the operating unit 60. Consequently, the battery pack 30 includes an insertion sensor (identification device) for the external terminal 35 that identifies which of the charging terminal and the power supply terminal has been inserted into the external terminal 35. Note that, for example, the battery pack 30 may also identify which terminal has been connected by communicating with the charging device or operating unit 60 side without using an insertion sensor. The external terminal 35 can be used for both charging the cylindrical batteries 42a and supplying power to the operating unit 60. Alternatively, the terminal for charging the cylindrical batteries 42a and the terminal for supplying power to the operating unit 60 may be separate terminals.

The handle 36 is provided on one end (on the head unit 20 side) of the battery pack 30 in the axial direction. Specifically, the front casing 31 is provided with a lid 38 which enables the head unit 20 side to be opened and closed. A shock absorbing sheet 39 that reduces the shock transmitted to the battery modules 32 is arranged between the lid 38 and the battery modules 32. The handle 36 is provided on the outside (on the head unit 20 side) surface of the lid 38. As mentioned above, because the battery pack 30 can be separated from the head unit 20 and the operating unit 60, a user can easily carry the battery pack 30 after separation by holding the handle 36.

As described above, the outer peripheral surface of the front casing 31 has no openings or seams or the like, but has openings or the like at both ends in the axial direction. Here, both ends of the battery pack 30 of the present embodiment are sealed with a sealing material. Therefore, the battery pack 30 is independently waterproof.

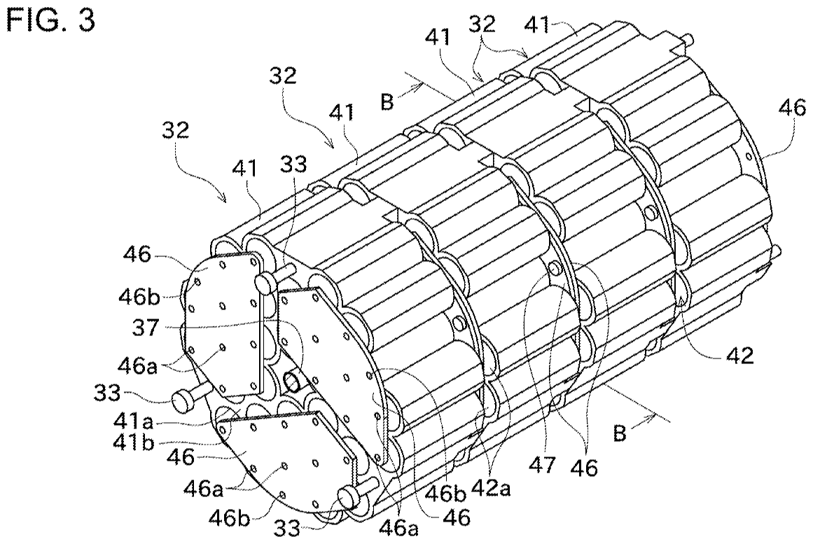

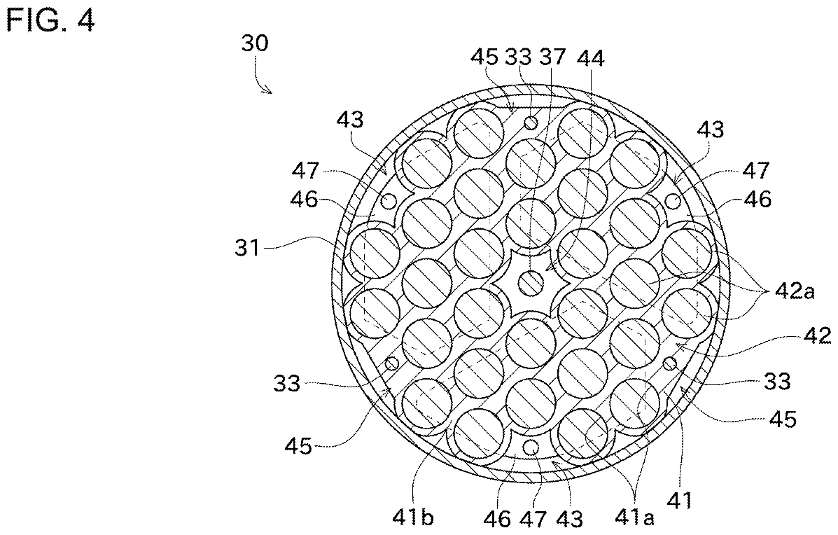

Next, the configuration of a battery module 32 will be described with reference to FIG. 2 to FIG. 4. FIG. 3 is a perspective view showing a configuration of a battery pack 30 in a state where the front casing 31, the lid 38, and the like have been removed. FIG. 4 is a cross-sectional view of the battery pack 30 taken along a plane perpendicular to the axial direction. Furthermore, FIG. 4 is a cross-sectional view from the arrow direction of the line B-B in FIG. 1.

As described above, the plurality of battery modules 32 are aligned in the axial direction. In the present embodiment, four battery modules 32 are aligned in the axial direction. The battery modules 32 each include a holder 41, a cylindrical battery group 42, a connection member 46, and a fixing device 47.

The holder 41 contains, for example, a flame retardant resin. The holder 41 has a plurality of battery holding holes 41a into which the cylindrical batteries 42a are inserted. In the present embodiment, the holder 41 has 30 battery holding holes 41a. A wall part 41b is formed around each battery holding hole 41a. The holder 41 holds the cylindrical batteries 42a individually by partitioning the adjacent cylindrical batteries 42a by means of the wall part 41b. Further, the cylindrical batteries 42a of the present embodiment have a circular cylindrical shape. Specifically, the cylindrical batteries 42a of the present embodiment have a structure in which a positive electrode, a separator, and a negative electrode and the like are arranged inside an exterior can having a circular cylindrical shape. Therefore, the battery holding holes 41a into which the cylindrical batteries 42a are inserted are holes having a circular cross-section. When the cylindrical batteries 42a have a rectangular cylindrical shape instead of a circular cylindrical shape, the battery holding holes 41a are holes having a matching rectangular cross-section. Silicon grease or the like may be applied between the holder 41 and the cylindrical batteries 42a to improve the heat dissipation effect. As a result, the thermal conductivity between the holder 41 and the cylindrical batteries 42a is increased, and the contact between them can be improved.

The cylindrical batteries 42a held by the holder 41 are connected in parallel and in series by the connection member 46. More specifically, a plurality of cylindrical batteries 42a are aligned in the radial direction (the direction perpendicular to the axial direction), and one-third of these are connected in parallel. That is to say, in a single battery module 32, a plurality of parallel-connected groups (three in the present embodiment) of cylindrical batteries 42a are formed. The parallel-connected groups of cylindrical batteries 42a are connected in series between adjacent battery modules 32. In other words, the cylindrical batteries 42a of the parallel-connected groups are connected in series across the number of holders 41 that are provided. Further, the parallel-connected groups of cylindrical batteries 42a are connected in series at both ends in the axial direction, and therefore, the number of cylindrical batteries 42a in the parallel-connected groups that are connected in series is three times the number of holders 41. As a result of serially connecting the parallel-connected groups in this manner by returning back at the ends in the axial direction, the axial direction length of the battery pack 30 is made shorter, and the number of cylindrical batteries 42a connected in series can also be increased. For example, if the return frequency mentioned above is N−1 times, the cylindrical batteries 42a can be connected without excess or deficiency by connecting in parallel 1/Nth of the cylindrical batteries 42a aligned in the radial direction. However, it is not necessary to connect the cylindrical batteries 42a by using all of the battery holding holes 41a of all of the holders 41. Therefore, at least one holder 41 may have battery holding holes 41a in which a cylindrical battery 42a is not inserted.

In a single battery module 32, the connection member 46 connects in parallel a plurality of the cylindrical batteries 42a aligned in the radial direction. Furthermore, the connection member 46 connects in series the cylindrical batteries 42a of battery modules 32 that are adjacent to each other. The connection member 46 is a plate-shaped member having conductivity. The connection member 46 has first connection holes 46a, which are provided in number to correspond to the parallel-connected groups and at positions matching the cylindrical batteries 42a. The connection member 46 is electrically connected to the terminals of the cylindrical batteries 42a through the first connection holes 46a. The connection method may, for example, use welding or fusing, or a connecting device. When a connection is performed by welding, it is more preferable to employ spot welding. When a connection is performed by fusing, it is more preferable to employ ultrasonic fusing. Furthermore, connection members 46 are arranged on both ends of the cylindrical batteries 42a in the axial direction. Therefore, between cylindrical batteries 42a that are adjacent to each other in the axial direction, the connection member 46 connected to one cylindrical battery 42a and the connection member 46 connected to the other cylindrical battery 42a are arranged so as to face each other. The connection members 46 that are arranged so as to face each other are electrically connected by being mechanically fixed. Specifically, second connection holes 46b are formed in the same positions in each of the connection members 46. The connection members 46 facing each other are fixed by matching the second connection holes 46b and inserting a fixing device 47. The fixing device 47 may be a rivet, or a bolt and nut. Furthermore, the connection members 46 facing each other can be connected by welding.

Next, a description will be given of the arrangement of the cylindrical batteries 42a in the radial direction, and in particular, the method of utilizing the space formed between the cylindrical batteries 42a and the front casing 31. Because the cylindrical batteries 42a and the battery holding holes 41a have the same arrangement, the arrangement of the battery holding holes 41a will be mainly described below. As shown in FIG. 4, in the present embodiment, the front casing 31 has a circular cylindrical shape, and the holder 41 also has a substantially circular cylindrical shape. At the center of the holder 41, battery holding holes 41a are formed at positions corresponding to the vertices of a regular hexagon, and these battery holding holes 41a form a first layer having a regular hexagonal shape. Among the battery holding holes 41a in the holder 41, the first layer is the layer of battery holding holes 41a positioned on the innermost side in the radial direction. Furthermore, a second layer of battery holding holes 41a is formed on the outside of the first layer in the radial direction. Specifically, in the second layer, battery holding holes 41a are formed on the outside of the battery holding holes 41a in the first layer in the radial direction. Furthermore, between these holes, battery holding holes 41a are also formed. In other words, in the second layer, battery holding holes 41a are formed at positions corresponding to the vertices of a regular hexagon, and battery holding holes 41a are also formed at positions corresponding to the sides of a regular hexagon. As a result, battery holding holes 41a are formed along the outlines of regular hexagons in the first layer and the second layer.

A third layer of battery holding holes 41a is formed on the outside of the battery holding holes 41a in the second layer. In the third layer, battery holding holes 41a are not formed at positions corresponding to the vertices of a regular hexagon, and battery holding holes 41a are formed at positions corresponding to the sides of a regular hexagon. As a result of forming the battery holding holes 41a in this manner, the battery holding holes 41a can be formed with a high density, and therefore, the cylindrical batteries 42a can be efficiently arranged. Furthermore, in the present embodiment, because the distance between the centers of adjacent battery holding holes 41a can be made constant, the amount of heat transferred between the cylindrical batteries 42a can be made uniform.

Moreover, in the present embodiment, because cylindrical batteries 42a are not arranged at positions corresponding to the vertices of a regular hexagon in the third layer, a total of six spaces are formed between the cylindrical batteries 42a and the front casing 31 when viewed in the axial direction (that is to say, in FIG. 4). In three of these spaces, because the holder 41 is recessed to the inside in the radial direction according to the arrangement of the cylindrical batteries 42a, neither a cylindrical battery 42a nor the holder 41 is arranged in these spaces. These spaces are referred to as first spaces 43.

The first spaces 43 are utilized for fixing the connection members 46 to each other. Specifically, the second connection holes 46b of the connection members 46 are formed so as to be positioned in the first spaces 43 when viewed in the axial direction. Therefore, the fixing devices 47 also fix the connection members 46 to each other in the first spaces 43. Furthermore, when the connection members 46 are fixed to each other by welding, such as by spot welding or the like, the work of bringing such as a welder into contact with, or near, the connection members 46 is made easier due to the formation of the first spaces 43, and the production process of the battery pack 30 can be simplified.

Furthermore, in the present embodiment, a cylindrical battery 42a is not arranged at the center of the holder 41 when viewed in the axial direction, which results in the formation of a space. This space is referred to as a second space 44. The second space 44 can be utilized for arranging a component that constitutes the battery pack 30. In the present embodiment, a harness 37 is arranged in the second space 44. A harness that transmits another electric signal or electric power may be arranged in the second space 44, or a component other than a harness may be arranged in the second space 44. Furthermore, the second space 44 may be utilized as an exhaust discharge path during thermal runaway of the cylindrical batteries 42a.

Moreover, among the six spaces mentioned above, a portion of the holder 41 is positioned in the three spaces which are not first spaces 43. These spaces are referred to as third spaces 45. The third spaces 45 are utilized for fixing the holders 41 to each other. Specifically, through holes are formed in the holder 41 at positions corresponding to the third spaces 45, and joining bolts 33 are fixed to the through holes. The joining bolts 33 pass through the plurality of holders 41 aligned in the axial direction.

As described above, by using the spaces formed between the cylindrical batteries 42a and the front casing 31 to connect the connection members 46, connect the holders 41, and arrange the harness 37 and the like, the internal space of the front casing 31 can be effectively utilized. Therefore, the size of the front casing 31 can be made smaller. Although three types of spaces are formed in the present embodiment, at least one of the second space 44 and the third spaces 45 does not have to be formed. Furthermore, even when these spaces are formed, they do not have to be utilized for connecting the holders 41 or arranging components or the like.

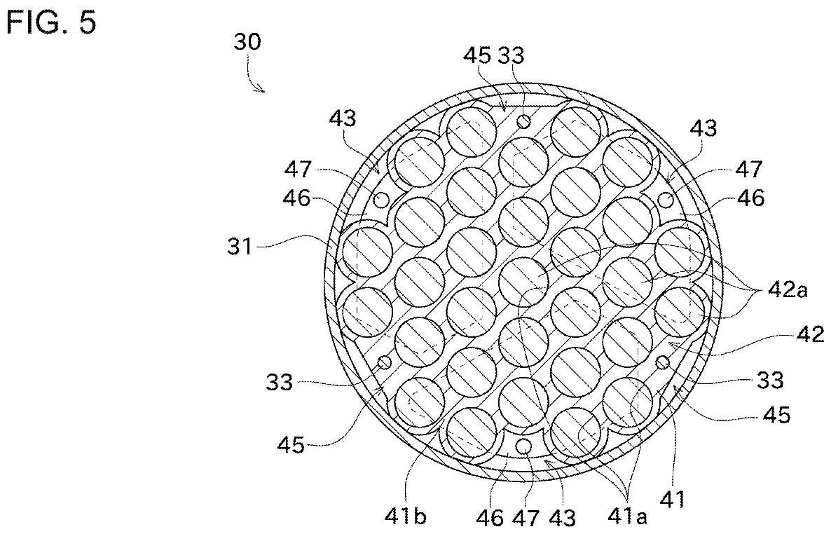

Next, a first modification of the first embodiment will be described. In the description of the first and subsequent modifications, the same or similar members as in the first embodiment will be given the same reference numerals in the drawings, and the description may be omitted. FIG. 5 is a cross-section of a holder 41 of the first modification.

The first embodiment has a configuration in which the second space 44 is formed at the center when the holder 41 is viewed from the axial direction. In contrast, in the first modification, a battery holding hole 41a is formed and a cylindrical battery 42a is arranged at the center when the holder 41 is viewed from the axial direction. Therefore, in the first modification, 31 battery holding holes 41a are formed in the holder 41. As a result of this configuration, the cylindrical batteries 42a can be arranged with a higher density.

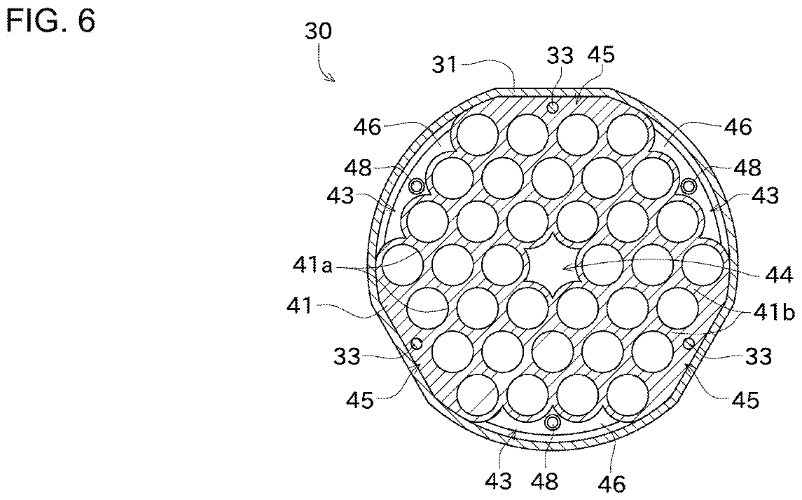

Next, a second modification of the first embodiment will be described. FIG. 6 is a cross-section of a holder 41 of the second modification.

In the first embodiment, battery holding holes 41a are not formed at positions corresponding to the vertices of a regular hexagon in the third layer. In contrast, in the second modification, battery holding holes 41a are formed at positions corresponding to the vertices of a regular hexagon in the third layer. Therefore, in the second modification, 36 battery holding holes 41a are formed in the holder 41. Furthermore, the outline of the holder 41 and the cylindrical battery group 42 has a regular hexagonal shape when viewed in the axial direction. Furthermore, in the second modification, the front casing 31 has a substantially regular hexagonal cylindrical shape so as to match the shape of the holder 41. Specifically, the shape is one in which some of the sides of a regular hexagon have been bent so as to project outward in the radial direction.

Therefore, in the second modification, first spaces 43 and third spaces 45 are formed between the cylindrical batteries 42a and the inner wall of the front casing 31. In the second modification, because the connection members 46 are welded (spot welded) to each other, weld marks 48 are formed on the connection members 46.

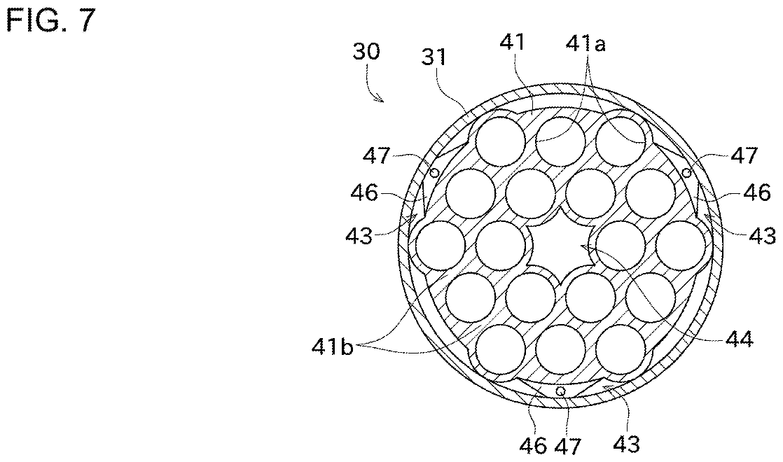

Next, a third modification of the first embodiment will be described. FIG. 7 is a cross-section of a holder 41 of the third modification.

In the first embodiment, battery holding holes 41a are formed across three layers. In contrast, in the third modification, battery holding holes 41a are formed across two layers. Therefore, in the third modification, 18 battery holding holes 41a are formed in the holder 41. Furthermore, in the third modification, battery holding holes 41a are also formed at positions corresponding to the vertices of a regular hexagon in the outermost layer in the radial direction, and therefore, in a similar manner to the second modification, the outline of the cylindrical battery group 42 when viewed in the axial direction has a regular hexagonal shape. In the third modification, the front casing 31 has a circular cylindrical shape. Moreover, in the third modification, the holders 41 are fixed to each other without utilizing the third spaces 45.

As described above, there are various possible modes for the number and arrangement of the battery holding holes 41a formed in the holder 41 (that is to say, the cylindrical batteries 42a). Furthermore, the shape of the front casing 31 may be a shape other than a circular cylindrical shape as long as at least the first spaces 43 are formed. Note that the features described in the first embodiment and the three modifications can be appropriately combined. For example, the feature of connecting the connection members 46 of the second modification by welding can be applied to the first embodiment, the first modification, and the third modification.

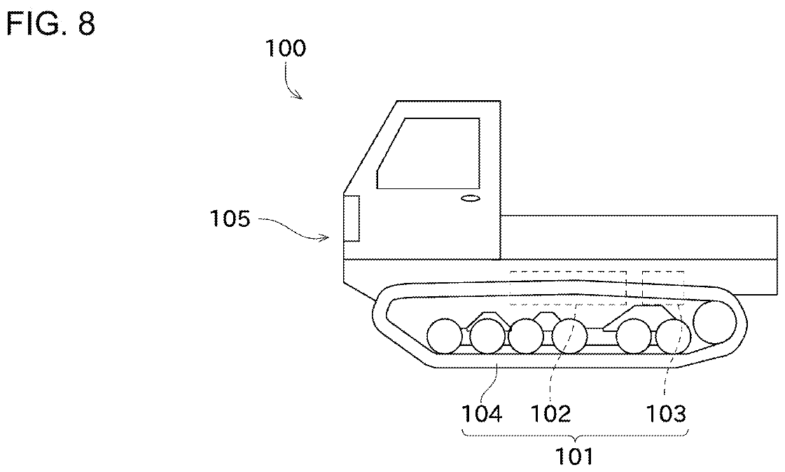

Next, second embodiment will be described. FIG. 8 is a side view of an all-terrain vehicle 100 provided with a propulsion device 101 according to a second embodiment.

The all-terrain vehicle 100 is a vehicle mainly for traveling on unpaved roads. The all-terrain vehicle 100 includes a propulsion device 101 and a vehicle body 105. The propulsion device 101 includes a battery pack 102, a hydraulic pump (drive source) 103, and a crawler (propulsion unit) 104.

The battery pack 102 has the configuration described in the first embodiment and in the modifications. The hydraulic pump 103 delivers hydraulic oil when electric power is supplied from the battery pack 102. The crawler 104 is driven as a result of the hydraulic oil delivered by the hydraulic pump 103, thereby causing the battery pack 102 to move. The crawler 104 may be driven by an electric motor instead of the hydraulic pump 103.

As described above, the battery pack 30 of the above embodiment includes a front casing 31 and a plurality of battery modules 32. The plurality of battery modules 32 are housed in the front casing 31. Each battery module 32 is provided with a cylindrical battery group 42 and a connection member 46. In the cylindrical battery group 42, a plurality of cylindrical batteries 42a, each of which is provided with terminals at both ends in an axial direction, is aligned in a direction that is perpendicular to the axial direction so that a first space 43 is formed between the cylindrical batteries 42a and an inner wall of the front casing 31 when viewed in the axial direction. The connection member 46 is fitted to both ends of the cylindrical battery group 42 in the axial direction so as to connect the terminals of the cylindrical batteries 42a to each other, and is partially positioned in the first space 43 when viewed in the axial direction. The battery modules 32 are arranged to align in the axial direction, and the connection members 46 of adjacent battery modules 32 are affixed to each other at portions that are positioned in the first space 43.

In the embodiment described above, the cylindrical batteries 42a are aligned so as to form the first space 43, and the connection members 46 are positioned in the first space 43. As a result, when a battery module 32 is aligned in the axial direction, part of the connection member 46 is exposed. Therefore, the work of affixing adjacent connection members 46 to each other can be easily performed. Furthermore, by having a plurality of battery modules 32, a large battery capacity can be ensured.

Furthermore, in the battery pack 30 of the above embodiment, the cylindrical batteries 42a are aligned to form a second space 44 at the center of each of the plurality of cylindrical battery groups 42 when viewed in the axial direction.

As a result, when the battery pack 30 is viewed from the axial direction, a space is formed that passes through the center of each battery module 32 in the axial direction. Therefore, for example, by arranging a component (such as a harness 37) included in the battery pack 30 in this space, the internal space of the front casing 31 can be effectively utilized.

Moreover, in the battery pack 30 of the above embodiment, each of the plurality of battery modules 32 includes a holder 41 that holds the cylindrical battery group 42, which is arranged so as to not overlap with an affixed portion (fixing device 47, weld mark 48) between the connection members 46 in the first space 43 when viewed in the axial direction.

As a result of the cylindrical battery group 42 being held by the holder 41, the cylindrical batteries 42a can be stabilized. Furthermore, by arranging the holder 41 so as to not overlap with an affixed portion between the connection members 46 when viewed in the axial direction, the ease of performing the work of affixing the connection members 46 to each other is maintained even in the above embodiment, which includes the holder 41.

In addition, in the battery pack 30 of the above embodiment, battery holding holes 41a are formed in the holder 41 for individually holding the cylindrical batteries 42a, and adjacent battery holding holes 41a are partitioned by a wall part 41b.

As a result of the cylindrical batteries 42a being partitioned by a wall part 41b, it is possible to prevent fire from spreading between the cylindrical batteries 42a. Further, in the present embodiment, because the wall part 41b is formed such that the distance between the cylindrical batteries 42a is uniform, it is possible to reduce variations in heat between the cylindrical batteries 42a.

Also, the battery pack 30 of the above embodiment includes a joining bolt 33 that joins a plurality of holders 41 arranged to align in the axial direction. The plurality of cylindrical battery groups 42 are aligned to form a third space 45 between the cylindrical batteries 42a and the inner wall of the front casing 31. The joining bolt 33 is arranged so as to pass through the holders 41 positioned in the third space 45.

As a result of the holders 41 being joined by the joining bolt 33, the battery modules 32 can be stabilized inside the front casing 31. Furthermore, because the holders 41 are joined by utilizing the third space 45, which is a space formed between the cylindrical batteries 42a and the front casing 31, the internal space of the front casing 31 can be effectively utilized.

Moreover, in the battery pack 30 of the above embodiment, at least part of the cylindrical battery group 42 is arranged along an outline of a regular hexagon when viewed in the axial direction.

As a result, because the cylindrical batteries 42a can be arranged with a high density, the internal space of the front casing 31 can be effectively utilized.

In addition, the propulsion device 13 (propulsion device 101) of the above embodiment includes a battery pack 30 (propulsion device 101), an electric motor 63 (hydraulic pump 103), and a screw 64 (crawler 104). The electric motor 63 (hydraulic pump 103) is driven by electric power supplied from the battery pack 30. The screw 64 (crawler 104) uses a drive force generated by the electric motor 63 (hydraulic pump 103) to generate a propulsive force that moves a moving body.

As described above, the propulsion device 13 of the above embodiment includes a plurality of battery modules 32. As a result, propulsion devices 13 and 101 having a large battery capacity are realized.

Furthermore, the propulsion device 13 of the above embodiment includes a rear casing 61 that houses the electric motor 63. The front casing 31 constitutes an outer shell of the propulsion device 13 and is configured so as to be detachable from the rear casing 61, and is provided with an external terminal 35 for charging the cylindrical battery groups 42 of the battery modules 32 by means of an external charging device. The screw 64 generates a propulsive force underwater.

In the propulsion device 13 described above, the front casing 31 of the battery pack 30 also serves as a casing of the propulsion device 13. As a result, a large space for arranging the cylindrical battery groups 42 can be ensured, and the propulsion device 13 can be made compact. Furthermore, because an external terminal is provided on the front casing 31, which is detachable from the rear casing 61, it is possible to charge the cylindrical battery groups 42 in a state where the front casing 31 is detached from the rear casing 61.

Although the preferred embodiments and modifications of the present invention have been described above, for example, the above configuration can be modified as follows.

The battery pack 30 of the above embodiment constitutes part of an integrated propulsion device 13 as a result of the head unit 20 and the operating unit 60 being attached thereto. Alternatively, a configuration is possible in which at least one of the head unit 20 and the operating unit 60 are separately arranged.

The battery pack 30 of the above embodiment includes a holder 41 that holds the cylindrical batteries 42a such that they are partitioned by the wall part 41b, but a configuration is possible in which the wall part 41b is not formed between the cylindrical batteries 42a. Furthermore, the holder 41 can be omitted by fixing the cylindrical batteries 42a using a film or the like in a state where they are aligned.

### DESCRIPTION OF REFERENCE NUMERALS

1 Electric sliding body
11 Surfboard
12 Support column
13 Propulsion device
30 Battery pack
31 Front casing (battery casing)
32 Battery module
33 Joining bolt (joining member)
41 Holder
41a Battery holding hole
42 Cylindrical battery group
42a Cylindrical battery
43 First space
44 Second space
45 Third space
46 Connection member
47 Fixing device
60 Operating unit
61 Rear casing (drive casing)
63 Electric motor (drive source)
64 Screw (propulsion unit)

1. A battery pack comprising:
a battery casing; and
a plurality of battery modules housed inside the battery casing, wherein
the plurality of battery modules each include:
a cylindrical battery group, in which a plurality of cylindrical batteries, each of which is provided with terminals at both ends in an axial direction, are aligned in a direction that is perpendicular to the axial direction to form a first space between the plurality of cylindrical batteries and an inner wall of the battery casing when viewed in the axial direction; and
connection members fitted to both ends of the cylindrical battery group in the axial direction to connect the terminals of the plurality of cylindrical batteries to each other, and partially positioned in the first space when viewed in the axial direction, and
the plurality of battery modules are arranged to align in the axial direction, and the connection members of battery modules adjacent to each other are affixed to each other at portions that are positioned in the first space.

2. The battery pack according to claim 1, wherein, in each cylindrical battery group, the plurality of cylindrical batteries are aligned to form a second space at a center of the cylindrical battery group when viewed in the axial direction.

3. The battery pack according to claim 1, wherein each of the plurality of battery modules includes a holder that holds the cylindrical battery group, the holder being arranged to avoid overlapping with affixed portions of the connection members in the first space when viewed in the axial direction.

4. The battery pack according to claim 3, wherein battery holding holes are formed in the holder for individually holding the plurality of cylindrical batteries, and the battery holding holes adjacent to each other are partitioned by a wall part.

5. The battery pack according to claim 3, comprising a joining member that joins a plurality of holders arranged to align in the axial direction, wherein
the cylindrical battery groups of the plurality of battery modules are aligned to form a third space between the cylindrical battery groups and the inner wall of the battery casing, and
the joining member is arranged to pass through the plurality of holders positioned in the third space.

6. The battery pack according to claim 1, wherein at least part of the cylindrical battery group is arranged along an outline of a regular hexagon when viewed in the axial direction.

7. A propulsion device comprising:
the battery pack according to claim 1;
a drive source which is driven by electric power supplied from the battery pack; and
a propulsion unit that uses a drive force generated by the drive source to generate a propulsive force that moves a moving body.

8. The propulsion device according to claim 7, comprising a drive casing that houses the drive source, wherein
the battery casing constitutes an outer shell of the propulsion device, is detachable from the drive casing, and is provided with an external terminal for charging the cylindrical battery groups of the plurality of battery modules by means of an external charging device, and
the propulsion unit generates the propulsive force underwater.
